(19) United States
(12) Patent Application Publication
(10) Pub. No.: US 2026/0227505 A1
(43) Pub. Date: Aug. 6, 2026

(54) CULTIVATED LAND NON-AGRICULTURAL PATTERN SPOT EXTRACTION METHOD AND DEVICE FUSED WITH MULTI-SOURCE SAR DATA

(71) Applicant: SURVEYING AND MAPPING INSTITUTE LANDS AND RESOURCE DEPARTMENT OF GUANGDONG PROVINCE, Guangdong (CN)

(72) Inventors: Yuanjun ZHONG, Guangdong (CN); Weijie XU, Guangdong (CN); Ziyang ZHU, Guangdong (CN); Zhaopu SONG, Guangdong (CN); Huajian ZHENG, Guangdong (CN); Bin WANG, Guangdong (CN); Xinyan LI, Guangdong (CN); Zhanpeng CHEN, Guangdong (CN); Jialin WANG, Guangdong (CN); Hongfei XU, Guangdong (CN); Xiaochun SHI, Guangdong (CN); Shiyang LUO, Guangdong (CN); Xiaofeng SONG, Guangdong (CN); Yuxiang LIAO, Guangdong (CN); Meng JIANG, Guangdong (CN)

(73) Assignee: SURVEYING AND MAPPING INSTITUTE LANDS AND RESOURCE DEPARTMENT OF GUANGDONG PROVINCE, Guangdong (CN)

(21) Appl. No.: 18/834,634

(22) PCT Filed: Oct. 16, 2023
(86) PCT No.: PCT/CN2023/124695

§ 371 Date: Jul. 31, 2024

(30) Foreign Application Priority Data
Aug. 9, 2023 (CN) 202310999175.7

(51) Int. Cl. G01S 13/90; G06T 11/26

(52) U.S. Cl. CPC G01S 13/9027; G06T 11/26

(57) ABSTRACT

The present invention discloses a cultivated land non-agricultural pattern spot extraction method and device fused with multi-source SAR data, and relates to the technical field of remote sensing image processing. According to the present invention, firstly, extraction of change pattern spots is performed by using SAR images, and then, the change pattern spots are classified, such that a problem that an optical image cannot be acquired in time is avoided, and meanwhile, manpower and material resources needed by field check are greatly reduced through the automatic extraction method. In addition, according to the implementation of the present invention, firstly, an SAR image coherence sequence diagram is calculated and acquired, and a requirement of true change pattern spot extraction is further divided by using a coherence coefficient, improving accuracy of a change pattern spot extraction result; and further, extracted change detection results are classified by using a high-resolution SAR image.

### TECHNICAL FIELD

The present invention relates to the technical field of remote sensing image processing, in particular to a cultivated land non-agricultural pattern spot extraction method and device fused with multi-source synthetic aperture radar (SAR) data.

### BACKGROUND

Optical remote sensing, as the main technical means to carry out remote sensing monitoring of crops for a long time, was first applied to land use, non-agricultural monitoring of cultivated land, and the like. It determines whether the cultivated land is for a non-agricultural use or not mainly by detecting a change in optical images and manual vision. In the optical remote sensing, the combination of the optical image supervision and field check is generally used to dynamically monitor the cultivated land every quarter. However, due to the influence of cloud and rainy weather, optical images cannot be acquired in time, and the field needs certain manpower and material resources. As a result, it is very difficult to monitor the cultivated land in real time. Synthetic aperture radar (SAR) is an active sensor that uses microwaves for sensing. Compared with optical sensors and other sensors, SAR imaging is not affected by weather, light intensity and other factors, can detect a target all day and all weather, and has a certain vegetation penetration ability. However, SAR images will be affected by coherent noise and a test working mode, resulting in a speckle, a shadow, a shortened slope and top-bottom inversion. In terms of visual perception, the contour and structural features of the SAR images are different from those of real objects, and the resolutions of the images are relatively low. Therefore, although the special imaging mechanism of SAR can provide rich information about ground targets, it brings some difficulties to image interpretation.

For short-term monitoring of the non-agricultural cultivated land in time, the use of the SAR images for change detection and identification is the most important focus at present. However, a traditional SAR image change detection method has problems of a change of an extracted change pattern spot being a false change, accumulation of classification errors, and the like. As a result, the accuracy and the reliability of a change detection result are reduced, and it is difficult to meet the business needs of short-term detection and identification of the non-agricultural cultivated land.

### SUMMARY

Aiming at the shortcomings in the prior art, the present invention provides a cultivated land non-agricultural pattern spot extraction method and device fused with multi-source SAR data. According to the present invention, a problem that optical images cannot be acquired in time is avoided, and meanwhile, manpower and material resources needed by field check are greatly reduced through the automatic extraction method, and accuracy of an extraction result of change pattern spots is improved.

In order to achieve the above purpose, the technical solutions of the present invention are as follows.

In a first aspect, a cultivated land non-agricultural pattern spot extraction method fused with multi-source SAR data is provided by the present invention, and includes the following steps:
acquiring Sentinel-1A SLC data of a study region within a set time period;
generating coherence map based on the Sentinel-1A SLC data, generating a coherence sequence diagram based on the coherence map, generating a standard deviation image based on the coherence sequence diagram, generating a binary image based on the standard deviation image, and generating change pattern spots based on the binary image; and
acquiring COSMO-SkyMed data of the study region; and
performing speckle filtering on the COSMO-SkyMed data by using a Lee Sigma algorithm, calculating, by taking the change pattern spots as a range, a statistical characteristic of the COSMO-SkyMed data subjected to the speckle filtering within the range to obtain change pattern spots having the COSMO-SkyMed statistical characteristic, selecting a plurality of samples of suspected newly-added artificial structure regions and a plurality of samples of non-artificial structure regions from the obtained change pattern spots having the COSMO-SkyMed statistical characteristic, training an SVM classifier with the plurality of samples, and classifying the obtained change pattern spots by the trained SVM classifier to finally obtain a change pattern spot of a suspected newly-added artificial structure.

In a second aspect, an automatic cultivated land non-agricultural pattern spot extraction system is provided by the present invention, and includes the following steps:
a data acquiring unit, configured to acquire Sentinel-1A SLC data of a study region within a set time period and COSMO-SkyMed data of the study region; and
a data processing unit, configured to execute the following steps:
generating coherence map based on the Sentinel-LA SLC data, generating a coherence sequence diagram based on the coherence map, generating a standard deviation image based on the coherence sequence diagram, generating a binary image based on the standard deviation image, and generating change pattern spots based on the binary image, and
performing speckle filtering on the COSMO-SkyMed data by using a Lee Sigma algorithm, calculating, by taking the change pattern spots as a range, a statistical characteristic of the COSMO-SkyMed data subjected to the speckle filtering within the range to obtain change pattern spots having the COSMO-SkyMed statistical characteristic, selecting a plurality of samples of suspected newly-added artificial structure regions and a plurality of samples of non-artificial structure regions from the obtained change pattern spots having the COSMO-SkyMed statistical characteristic, training an SVM classifier with the plurality of samples, and classifying the obtained change pattern spots by the trained SVM classifier to finally obtain a change pattern spot of a suspected newly-added artificial structure.

In a third aspect, an electronic device is provided by the present invention, and includes a processor and a memory;
wherein the memory is configured to store a program; and
the processor is configured to execute the program to implement the method as described above.

In a fourth aspect, a computer-readable storage medium is provided by the present invention, wherein the storage medium stores a program, and the program is executed by a processor to implement the method as described above.

In a fifth aspect, a computer program product or a computer program is provided by the present invention, and includes a computer instruction stored in a computer-readable storage medium. A processor of a computer device can read the computer instruction from the computer-readable storage medium, and the processor executes the computer instruction to enable the computer device to execute the above method.

Compared with the prior art having the problems that an optical remote sensing method cannot obtain images in time, and for traditional SAR images, a change detection and extraction accuracy rate is relatively low and change classification and identification accuracy is relatively poor, the present invention has the beneficial effects that an automatic cultivated land non-agricultural pattern spot extraction method based on multi-scale time sequence SAR characteristics and a device related to the method are provided. The SAR images have all-day and all-weather advantages, and allow target information to be acquired in a large range and a long distance. Using pure SAR solves the problem that images cannot be obtained in time; coherence coefficients for evaluating the coherence standard of two SAR images in time sequence SAR images are calculated and sequence coherence maps are formed, and information of tiny changes on the maps is accurately measured, such that the accuracy of extracting change pattern spots is further improved. Finally, using the high-resolution SAR images to calculate characteristic information of the change pattern spots achieves the classification of the changing pattern spots.

### BRIEF DESCRIPTION OF THE DRAWINGS

In order to provide a more clearly technical solution in the embodiments of the present invention, a brief introduction will be given to the following drawings required in the embodiments. Apparently, the following drawings in the subsequent description show merely some embodiments of the present invention, and those skilled in the art may still derive other drawings from these following drawings without creative efforts.

FIG. 1 is a flow chart of an automatic cultivated land non-agricultural pattern spot extraction method according to an embodiment of the present invention;

FIG. 2 is another flow chart of an automatic cultivated land non-agricultural pattern spot extraction method according to an embodiment of the present invention;

FIG. 3 is a schematic structural diagram of an automatic cultivated land non-agricultural pattern spot extraction system according to an embodiment of the present invention; and

FIG. 4 is a schematic structural diagram of an electronic device according to an embodiment of the present disclosure.

### DETAILED DESCRIPTION OF THE EMBODIMENTS

The technical solutions in the embodiments of the present invention will be clearly and completely described below with reference to the drawings in the embodiments of the present invention. Obviously, the embodiments described are merely some but not all embodiments of the present invention. Based on the embodiments of the present invention, all other embodiments derived by those of ordinary skills in the art without creative efforts shall fall within the protection scope of the present invention.

### EMBODIMENT

It is to be noted that terms “first,” “second,” and the like in the description and claims, as well as the above drawings, of the present invention are used for the purpose of distinguishing similar objects instead of indicating a particular order or sequence. It should be understood that data used in this way are interchangeable where appropriate, such that the embodiments of the present invention described herein can be implemented in a sequence other than those illustrated or described herein. In addition, the terms “comprise/include”, “have”, and any of its variations are intended to cover a non-exclusive inclusion. For example, a process, method, system, product or device containing a series of steps or units is not necessarily limited to those explicitly listed, but may include other steps or units that are not explicitly listed or inherent to these processes, methods, products or devices.

### Embodiment 1

Aims at solving the problems that the optical images cannot be acquired in time, the accuracy of change detection and extraction results of the SAR images is relatively low, and the change identification and classification is inaccurate, an automatic cultivated land non-agricultural pattern spot extraction method based on multi-scale time sequence SAR characteristics is provided by the embodiment of the present invention. In the method, first, change pattern spots are extracted only by using SAR images, and then, are classified, such that the problem that the optical images cannot be obtained in time is avoided. Meanwhile, the automatic extraction method greatly reduces the manpower and material resources needed by field check. In addition, according to the implementation of the present invention, firstly, an SAR image coherence sequence diagram is calculated and acquired, and a requirement of true change pattern spot extraction is further divided by using a coherence coefficient, improving accuracy of a change pattern spot extraction result; and further, the extracted change detection results are classified by using a high-resolution SAR image, such that a more accurate classification result is achieved.

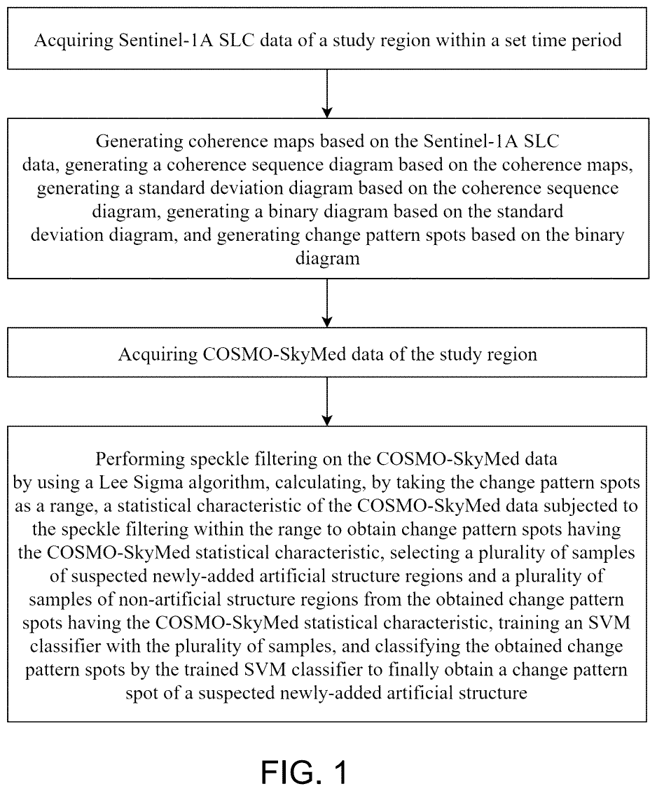

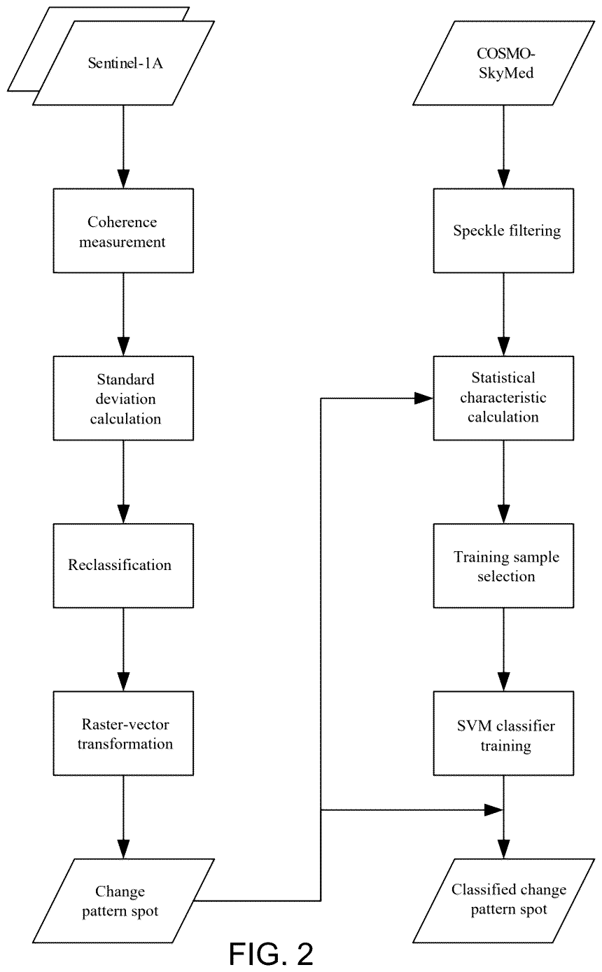

Referring to FIG. 1 and FIG. 2, a cultivated land non-agricultural pattern spot extraction method fused with multi-source SAR data specifically may includes the following steps.

In step 1, Sentinel-1A SLC data of a study region within a set time period are acquired.

Coherence maps are generated based on the Sentinel-1A SLC data, a coherence sequence diagram is generated based on the coherence maps, a standard deviation image is generated based on the coherence sequence diagram, a binary image is generated based on the standard deviation image, and change pattern spots are generated based on the binary image.

This step mainly achieves the change pattern spot extraction, and the process may be divided into the following sub-steps.

In step 101, Sentinel-1A SLC data of the study region within two months are acquired.

In step 102, coherence measurement is performed on the Sentinel-1A SLC data, and this step includes: (1) sorting the data according to an acquisition time order thereof; and (2) acquiring the coherence maps by sequentially calculating coherence coefficients of images in two successive time periods through a following calculation equation,

$$γ = \frac{\vert 〈 {S}_{1} \cdot {S}_{2}^{*} 〉 \vert}{\sqrt{〈 {S}_{1} \cdot {S}_{1}^{*} 〉 〈 {S}_{2} \cdot {S}_{2}^{*} 〉}}$$

wherein γ represents a coherence coefficient, S₁ and S₂ represent a complex interference image pair, * represents a complex conjugate, and < > represents an expected value.

In step 103, the calculated coherence maps are arranged in a time sequence, and the coherence sequence diagram is generated by combining the arranged coherence maps.

In step 104, standard deviations of the coherence sequence diagram are calculated, and a standard deviation image is obtained by taking a picture element having the standard deviation greater than 0.85 times of a maximum standard deviation among the standard deviations as a suspected change region, wherein this value is an empirical value obtained based on experimental data, and can achieve a balance between a recall ratio and an accuracy rate.

In step 105, the standard deviation image is reclassified as a binary image, wherein 0 represents a change, and 1 represents no change.

In step 106, raster-vector transformation is performed on the obtained binary image, areas of pattern spots are calculated, and a change pattern spot having an area less than 200 square meters is deleted to finally obtain a target change pattern spot.

In step 2, COSMO-SkyMed data of the study region are acquired.

Speckle filtering is performed on the COSMO-SkyMed data by using a Lee Sigma algorithm; by taking the change pattern spots as a range, a statistical characteristic of the COSMO-SkyMed data subjected to the speckle filtering within the range is calculated to obtain change pattern spots having the COSMO-SkyMed statistical characteristic, a plurality of samples of suspected newly-added artificial structure regions and a plurality of samples of non-artificial structure regions are selected from the obtained change pattern spots having the COSMO-SkyMed statistical characteristic, an SVM classifier is trained with the plurality of samples, and the obtained change pattern spots are classified by the trained SVM classifier to finally obtain a change pattern spot of a suspected newly-added artificial structure.

This step mainly achieves the change pattern spot extraction, and the process may be divided into the following sub-steps.

In step 201, COSMO-SkyMed data of the study region are acquired.

In step 202, the Lee Sigma algorithm is selected for performing the speckle filtering on the acquired COSMO-SkyMed data to acquire relatively pure SAR data, wherein the window size is set to 5*5, and a specific algorithm is as follows:

$${\hat{Z}}_{i , j} = {{\sum }_{k = i - n}}^{k = i + n} {{\sum }_{i = j - n}}^{i = j + n} {δ}_{k , l} {Z}_{k , l} / {{\sum }_{k = i - n}}^{k = i + n} {{\sum }_{i = j - n}}^{i = j + n} {δ}_{k , l} ,$$

and

$${δ}_{k , l} = \{ \begin{matrix}1 , if ( 1 - 2 δ ) {Z}_{i , j} \leq {Z}_{k , l} \leq ( 1 + 2 δ ) {Z}_{i , j} \\ 0 , otherwise\end{matrix} .$$

In the equations, (i, j) represents coordinate values of a filtering point; Z_{i,j} represents a gray value before filtering; \hat{Z}_{i,j} represents a filtered gray value, and n represents the size of a filtering window.

In step 203, by taking the change pattern spot obtained in step 106 as a range, ten statistical characteristics of the COSMO-SkyMed data within the range are calculated, and mainly include: Count, Sum, Mean, Median, St Dev, Minimum, Maximum, Range, Minority, Majority, Variety and Variance.

In step 204, 500 samples of the suspected newly-added artificial structure regions and 500 samples of the non-artificial structure regions are manually selected from the change pattern spots having the COSMO-SkyMed statistical characteristics obtained in step 203, and the SVM classifier is trained with the samples.

In step 205, the change pattern spots are classified, that is, all the change pattern spots obtained in step 203 are classified by using the trained SVM classifier, so as to finally obtain the change pattern spot of the suspected newly-added artificial structure.

### Embodiment 2

A specific embodiment is described as follows.

In S1, Sentinel-1A SLC data and COSMO-SkyMed data from April to May in Leizhou and Shaoguan (Guangdong, China) are acquired.

In S2, the acquired Sentinel-1A SLC data are sorted according to an acquisition time order thereof, and the coherence maps are acquired by sequentially calculating coherence coefficients of images in two successive time periods.

In S3, the calculated coherence maps are arranged in a time sequence, and the coherence sequence diagram is generated by combining the arranged coherence maps.

In S4, standard deviations of the coherence sequence diagram obtained in S3 are calculated, and a standard deviation image is obtained by taking a picture element having the standard deviation greater than 0.85 times of the maximum standard deviation among the standard deviations as a suspected change region.

In S5, the standard deviation image is reclassified as a binary image.

In S6, raster-vector transformation is performed on the obtained binary image, areas of pattern spots are calculated, and a change pattern spot having an area less than 200 square meters is deleted to finally obtain target change pattern spots.

In S7, Lee Sigma algorithm is selected for performing the speckle filtering on the COSMO-SkyMed data acquired in S1 to obtain relatively pure SAR data, wherein the window size is set to 5*5.

In S8, by taking the change pattern spots obtained in S6 as a range, ten statistical characteristics of the COSMO-SkyMed data within the range are calculated, and mainly include: Count, Sum, Mean, Median, St Dev, Minimum, Maximum, Range, Minority, Majority, Variety and Variance.

In S9, 500 samples of the suspected newly-added artificial structure regions and 500 samples of the non-artificial structure regions are manually selected from the change pattern spots having the COSMO-SkyMed statistical characteristics obtained in S8, and the SVM classifier is trained with the samples.

In S10, all the change pattern spots obtained in S8 are classified by using the trained SVM classifier, so as to finally obtain a change pattern spot of a suspected newly-added artificial structure.

In S11, the accuracy of the acquired change pattern spot of the suspected newly-added artificial structure is evaluated.

The final accuracy evaluation results are as follows.

After manual check (by indoor comparison with high-resolution images) of results that cultivated land have been occupied by structures in Leizhou and Shaoguan, it can be determined that the accuracy rates in Leizhou and Shaoguan are 73.13% and 61.2%, respectively, and the overall accuracy rate is 66.45%.

### Embodiment 3

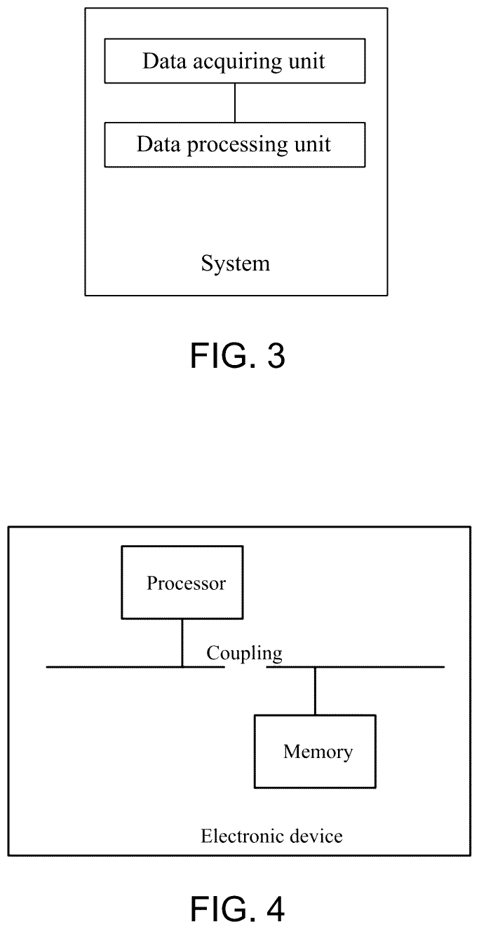

Referring to FIG. 3, based on the same inventive concept, an automatic cultivated land non-agricultural pattern spot extraction system is provided by an embodiment of the present invention, and includes:
a data acquiring unit, configured to acquire Sentinel-1A SLC data of a study region within a set time period and COSMO-SkyMed data of the study region; and
a data processing unit, configured to execute the following steps:
generating coherence maps based on the Sentinel-1A SLC data, generating a coherence sequence diagram based on the coherence maps, generating a standard deviation image based on the coherence sequence diagram, generating a binary image based on the standard deviation image, and generating change pattern spots based on the binary image; and
performing speckle filtering on the COSMO-SkyMed data by using a Lee Sigma algorithm, calculating, by taking the change pattern spots as a range, a statistical characteristic of the COSMO-SkyMed data subjected to the speckle filtering within the range to obtain change pattern spots having the COSMO-SkyMed statistical characteristic, selecting a plurality of samples of suspected newly-added artificial structure regions and non-artificial structure regions from the obtained change pattern spots having the COSMO-SkyMed statistical characteristic, training an SVM classifier with the plurality of samples, and classifying the obtained change pattern spots by the trained SVM classifier to finally obtain change pattern spots of a suspected newly-built artificial structure.

Because this system is a system corresponding to the automatic cultivated land non-agricultural pattern spot extraction method according the embodiments of the present invention and the principle of solving the problem by this system is similar to that in this method, the implementation of this system may refer to the implementation process of the above method embodiments, which will not be repeated herein.

### Embodiment 4

Referring to FIG. 4, based on the same inventive concept, an electronic device is further provided by an embodiment of the present invention, and includes a processor and a memory, wherein at least one instruction, at least one program, a code set or an instruction set is stored in the memory, and the at least one instruction, the at least one program, the code set or the instruction set is loaded and executed by the processor, so as to implement the automatic cultivated land non-agricultural pattern spot extraction method as described above.

It can be understood that the memory may include a random access memory (RAM) or a read-only memory. Optionally, the memory includes a non-transitory computer-readable storage medium. The memory may be used to store an instruction, a program, a code, a code set or an instruction set. The memory may include a storage program area and a memory data area, wherein the memory program area may store an instruction for implementing an operating system, an instruction for implementing at least one function, instructions for implementing the various method embodiments described above, and the like. The storage data area may also store data created by a server in use, and the like.

The processor may include one or more processing cores, connects all parts of the whole server using various interfaces and lines, and executes various functions of the server and processes data by running or executing an instruction, program, code set or instruction set stored in the memory and invoking data stored in the memory. Optionally, the processor may be implemented by using at least one of hardware forms of a digital signal processing (DSP), a field-programmable gate array (FPGA), and a programmable logic array (PLA). The processor may integrate one or a combination of two of a central processing unit (CPU), a modem, and the like. The CPU mainly processes operating systems, applications, and the like. The modem is used to process wireless communication. It can be understood that the above modem may also not be integrated into the processor and is implemented by a single communication chip.

Because this electronic device is an electronic device corresponding to the automatic cultivated land non-agricultural pattern spot extraction method according the embodiments of the present invention and the principle of solving the problem by this electronic device is similar to that in this method, the implementation of this electronic device may refer to the implementation process of the above method embodiments, which will not be repeated herein.

### Embodiment 5

Based on the same inventive concept, a computer-readable storage medium is further provided by an embodiment of the present invention, wherein at least one instruction, at least one program, a code set or an instruction set is stored in the storage medium, and the at least one instruction, the at least one program, the code set or the instruction set is loaded and executed by a processor, so as to implement the automatic cultivated land non-agricultural pattern spot extraction method as described above.

It can be understood by those skilled in the art that all or part of the steps in various methods of the above embodiments can be completed by instructing related hardware through a program. The program may be stored in a computer-readable storage medium, which includes: a read-only memory (ROM), a random access memory (RAM), a programmable read-only memory (PROM), an erasable programmable read only memory (EPROM), a one-time programmable read-only memory (OTPROM), an electrically-erasable programmable read-only memory (EEPROM), a compact disc read-only memory (CD-ROM) or other optical disc memories, magnetic disk memories, magnetic tape memories, or any other computer-readable media that can be used to carry or store data.

Because this storage medium is a storage medium corresponding to the automatic cultivated land non-agricultural pattern spot extraction method according the embodiments of the present invention and the principle of solving the problem by this storage medium is similar to that in this method, the implementation of this storage medium may refer to the implementation process of the above method embodiments, which will not be repeated herein.

### Embodiment 6

In some possible embodiments, various aspects of the method provided by the embodiments of the present invention may be alternatively implemented in the form of a program product including a program code; and when the program product is run on a computer device, the program code enables the computer device to execute the steps of the automatic cultivated land non-agricultural pattern spot extraction method according to various exemplary embodiments of the present invention described above in the Description. The executable computer program code or “code” for executing various embodiments may be written in high-level programming languages such as C, C++, C#, Smalltalk, Java, JavaScript, Visual Basic, structured query language (for example, Transact-SQL), Perl, or in various other programming languages.

It should be understood that various parts of the present invention may be implemented in hardware, software, firmware or a combination thereof. In the above embodiments, a plurality of steps or methods may be implemented by software or firmware stored in a memory and executed by a suitable instruction execution system. For example, if it is implemented in hardware, as in another embodiment, it can be implemented by any one of the following technologies or a combination thereof know in the art: a discrete logic circuit with a logic gate for implementing a logic function on a data signal, an application-specific integrated circuit with a suitable combinational logic gate, a programmable gate array (PGA), a field programmable gate array (FPGA), etc.

In the description of the Description, the description referring to the terms such as “one embodiment”, “some embodiments”, “example”, “particular example” or “some examples” are intended to indicate that a particular characteristic, structure, material or feature described in combination with this embodiment or example is included in at least one embodiment or example of the present invention. In the Description, the schematic expressions of the above terms are not necessarily aimed at the same embodiment or example. Furthermore, the particular characteristic, structure, material or feature described may be combined in any one or more embodiments or examples in a suitable manner. In addition, those skilled in the art can combine and compose different embodiments or examples and characteristics of different embodiments or examples described in this Description without contradicting each other.

The above embodiments are only for illustrating the technical conception and features of the present invention, and their purpose is to enable those skilled in the art to understand the content of the present invention and to implement it accordingly, without limiting the protection scope of the present invention. Any equivalent changes or modifications made in accordance with the essence of the content of the present invention shall be included in the protection scope of the present invention.

1. A cultivated land non-agricultural pattern spot extraction method fused with multi-source SAR data, the method comprising the following steps:
acquiring Sentinel-1A SLC data of a study region within a set time period;
generating coherence maps based on the Sentinel-1A SLC data, generating a coherence sequence diagram based on the coherence maps, generating a standard deviation image based on the coherence sequence diagram, generating a binary image based on the standard deviation image, and generating change pattern spots based on the binary image;
acquiring COSMO-SkyMed data of the study region; and
performing speckle filtering on the COSMO-SkyMed data by using a Lee Sigma algorithm, calculating, by taking the change pattern spots as a range, a statistical characteristic of the COSMO-SkyMed data subjected to the speckle filtering within the range to obtain change pattern spots having a COSMO-SkyMed statistical characteristic, selecting a plurality of samples of suspected newly-added artificial structure regions and a plurality of samples of non-artificial structure regions from the obtained change pattern spots having the COSMO-SkyMed statistical characteristic, training an SVM classifier with the plurality of samples, and classifying the obtained change pattern spots by the trained SVM classifier to finally obtain a change pattern spot of a suspected newly-added artificial structure.

2. The cultivated land non-agricultural pattern spot extraction method according to claim 1, wherein generating the coherence maps based on the Sentinel-1A SLC data specifically comprises:
performing coherence measurement on the Sentinel-1A SLC data, wherein the Sentinel-1A SLC data are sorted according to an acquisition time order thereof; and the coherence maps are acquired by sequentially calculating coherence coefficients of images in two successive time periods through a following calculation equation,
$$γ = \frac{\vert 〈 {S}_{1} \cdot {S}_{2}^{*} 〉 \vert}{\sqrt{〈 {S}_{1} \cdot {S}_{1}^{*} 〉 〈 {S}_{2} \cdot {S}_{2}^{*} 〉}} ,$$
wherein γ represents a coherence coefficient, S₁ and S₂ represent a complex interference image pair, * represents a complex conjugate, and < > represents an expected value.

3. The cultivated land non-agricultural pattern spot extraction method according to claim 1, wherein generating the coherence sequence diagram based on the coherence maps specifically comprises:
arranging the coherence maps in a time sequence, and generating the coherence sequence diagram by combining the arranged coherence maps.

4. The cultivated land non-agricultural pattern spot extraction method according to claim 1, wherein generating the standard deviation image based on the coherence sequence diagram specifically comprises:
calculating standard deviations of the coherence sequence diagram, and obtaining the standard deviation image by taking a picture element having a standard deviation greater than 0.85 times of a maximum standard deviation among the standard deviations as a suspected change region.

5. The cultivated land non-agricultural pattern spot extraction method according to claim 1, wherein generating the binary image based on the standard deviation image specifically comprises:
reclassifying the standard deviation image as the binary image, wherein the binary image contains a binary image where 0 represents a change, and 1 represents no change.

6. The cultivated land non-agricultural pattern spot extraction method according to claim 1, wherein generating the change pattern spot based on the binary image specifically comprises:
performing raster-vector transformation on the obtained binary image, calculating areas of pattern spots, and deleting a change pattern spot having an area less than 200 square meters to finally obtain a target change pattern spot.

7. The cultivated land non-agricultural pattern spot extraction method according to claim 1, wherein the Lee Sigma algorithm is selected for performing the speckle filtering to acquire relatively pure SAR data, a window size is set to 5*5, and a specific algorithm is as follows:
$${\hat{Z}}_{i , j} = {{\sum }_{k = i - n}}^{k = i + n} {{\sum }_{i = j - n}}^{i = j + n} {δ}_{k , l} {Z}_{k , l} / {{\sum }_{k = i - n}}^{k = i + n} {{\sum }_{i = j - n}}^{i = j + n} {δ}_{k , l} , and$$
$${δ}_{k , l} = \{ \begin{matrix}1 , if ( 1 - 2 δ ) {Z}_{i , j} \leq {Z}_{k , l} \leq ( 1 + 2 δ ) {Z}_{i , j} \\ 0 , otherwise\end{matrix} ,$$
wherein in the equations, (i, j) represents coordinate values of a filtering point; Z_{i,j} represents a gray value before filtering; \hat{Z}_{i,j} represents a filtered gray value, and n represents a size of a filtering window.

8. A n automatic cultivated land non-agricultural pattern spot extraction system, comprising:
a data acquiring circuit, configured to acquire Sentinel-1A SLC data of a study region within a set time period and COSMO-SkyMed data of the study region; and
a data processing circuit, configured to execute the following steps:
generating coherence maps based on the Sentinel-1A SLC data, generating a coherence sequence diagram based on the coherence maps, generating a standard deviation image based on the coherence sequence diagram, generating a binary image based on the standard deviation image, and generating change pattern spots based on the binary image; and
performing speckle filtering on the COSMO-SkyMed data by using a Lee Sigma algorithm, calculating, by taking the change pattern spots as a range, a statistical characteristic of the COSMO-SkyMed data subjected to the speckle filtering within the range to obtain change pattern spots having a COSMO-SkyMed statistical characteristic, selecting a plurality of samples of suspected newly-added artificial structure regions and a plurality of samples of non-artificial structure regions from the obtained change pattern spots having the COSMO-SkyMed statistical characteristic, training an SVM classifier with the plurality of samples, and classifying the obtained change pattern spots by the trained SVM classifier to finally obtain a change pattern spot of a suspected newly-added artificial structure.

9. An electronic device, comprising a processor and a memory, wherein at least one instruction, at least one program, a code set or an instruction set is stored in the memory, and the at least one instruction, the at least one program, the code set or the instruction set is loaded and executed by the processor to implement the cultivated land non-agricultural pattern spot extraction method according to claim 1.

10. A computer-readable storage medium, wherein at least one instruction, at least one program, a code set or an instruction set is stored in the storage medium, and the at least one instruction, the at least one program, the code set or the instruction set is loaded and executed by a processor to implement the cultivated land non-agricultural pattern spot extraction method according to claim 1.
